(19) United States
(12) Patent Application Publication
(10) Pub. No.: US 2006/0048889 A1
(43) Pub. Date: Mar. 9, 2006

(54) Method for connecting a chip and a substrate

(75) Inventors: Michael Feil, Munich (DE); Martin Koenig, Munich (DE)

Correspondence Address: LERNER AND GREENBERG, PA, P O BOX 2480, HOLLYWOOD, FL, 33022-2480, US

(73) Assignee: Fraunhofer-Gesellschaft zur Forderung der angewandten Forschung e.V.

(21) Appl. No.: 11/088,514

(22) Filed: Mar. 24, 2005

(30) Foreign Application Priority Data
Mar. 23, 2004 (DE) 10 2004 014 214.9

(51) Int. Cl. B29C 65/00

(52) U.S. Cl. 156/285

(57) ABSTRACT

In a method of connecting a chip and a substrate, an adhesive having conductive particles is initially provided. The chip and the substrate each include at least one pad on one appropriate side. The adhesive is applied onto one side of the substrate or onto one side of the chip, and the chip and the substrate are connected, the pads being aligned one below the other. Subsequently, this arrangement is pressurized such that in the region between the pads of the chip and the substrate, local compaction of the adhesive results, and the conductive particles adhere to the pads. Finally, the adhesive is hardened.

The present invention relates to the field of connecting chips and here, in particular, it relates to a method of connecting a chip with a substrate by means of a conductive adhesive. In particular, the present invention relates to a method of connecting a chip and a substrate by means of a conductive adhesive which is independent of a pad geometry of the pads of the chip and the substrate.

Electronic devices have increasingly been used both in everyday-life and in special applications. In manufacturing, the electronic devices and/or semiconductor devices, which are usually referred to as chips, need to be connected with a substrate. Instead of connecting chip and substrate, one also connects chip and chip, chip and wafer or substrate and substrate.

Conventionally, various methods have been used for connecting chips. In the wiring process, the chip is attached to a substrate by means of an adhesive, the electrical contacts being established by applying thin metal wires to the pads of the chip and to the associated contact pads of the substrate. A disadvantage of this method is the separation of the mechanical and electrical connections, which requires that separate steps be performed for connecting and/or contacting. In addition, the thin metal wires required for electrical connection represent an additional inductive component which negatively impacts the behavior of the microchip, in particular its switching speeds.

Another process that has been increasingly used recently is so-called flip-chip technology. With this method, the chip is soldered or glued, with its active side down, and consequently with its pads down, to the respective pads of the substrate. Conventionally, the pads have had to be provided with so-called bumps on one or both sides so as to ensure reliable contact. Bumps are small elevations typically composed of metal. Consequently, the use of bumps limits a thickness of the connection, so that such a connection is clearly above 30 μm, typically even above 50 μm. The advantage of the method as compared with applying wires is, among others, that mechanical and electrical connections are achieved in one process step.

Three different possibilities are known with regard to the adhesive used for connecting.

The first possibility includes the use of an isotropically conductive adhesive wherein a small droplet of an adhesive, which may be, for example, a conducting glue filled with silver, is applied to each individual pad of the chip and/or of the substrate. Thus, the method is similar to soldering, however with a conducting adhesive being used instead of the solder. To achieve a reliable connection, a so-called underfill process, i.e. filling of the resulting gap with a filling material, usually follows.

The second of the possibilities mentioned includes the use of an anisotropically conducting adhesive (ACA). Here, an anisotropically conducting adhesive is spread on the entire surface area underneath the chip, the chip and the substrate being connected after mutual positioning. Subsequently, the adhesive is hardened by applying a temperature and, simultaneously, pressure. The anisotropically conducting adhesive comprises conductive beads embedded in a non-conducting resin matrix. By applying a pressure, the beads in the contact regions are slightly deformed and touch each other, so that electrical contact results in these regions, whereas in the remaining regions, the adhesive maintains its insulating action. The shortest hardening times currently achieved for an anisotropically conducting adhesive are about 10 seconds.

A third possibility is to use an insulating adhesive which is spread on the entire surface area of the chip after the connecting process. In this method, an electrical connection between the pads of the chip and the contact pads of the substrate is achieved in that the glue is displaced in the pad areas by the bumps, which causes the contact metalization of the chip and of the substrate to make direct contact. To achieve this, pressure must be applied between the chip and the substrate, similarly to the anisotropic connection. Said pressure must be maintained during hardening while applying a temperature.

To perform hardening while simultaneously applying pressure and temperature, as is required for connecting by means of an anisotropically conducting adhesive and for connecting by means of an insulating adhesive, is expensive in terms of production engineering and has unfavorable effects with regard to production in bulk numbers, which may comprise a production rate of several thousand items per hour.

Many semiconductor devices with low current requirements have two-pole arrays. In addition to diodes, typical examples include integrated circuits of contactless chip cards or specific so-called smart labels, i.e. devices which may be read out, and/or may have information written onto them, in a contactless manner. They may be extremely thin, so that they may be embedded in appropriate support substrates which will be attached to goods, packets, etc. Along with an antenna, these integrated circuits form a circuit, so that absorption of energy and data transmission may be effected via this antenna, these systems being optimized toward as low a power consumption as possible. The integrated circuit is typically operated with an alternating current, the alternating current being internally rectified so as to provide direct voltage for power supply.

When connecting, requirements placed upon such chips having two poles often have differ from those placed upon chips having many pads. To name a few examples, chips provided for transponder applications in smart labels require an extremely thin connection layer to enable flexibility and integration in, for example, paper. In contrast to chips having many pads of small surface areas, however, precise positioning is not of crucial importance for chips with few pads of large surface areas. In addition, no galvanically conducting connection is required between the pads of the chip and the contact pads of the substrate in the case of applications having AC power coupled in.

The known methods that have been developed with regard to electrically connecting chips with pads of small surface areas thus do not constitute optimum solutions with regard to requirements placed upon connecting chips which have few pads or couple in AC power.

DE 101 17 929 A discloses a method of connecting a chip with a substrate, wherein an adhesive is provided whose conductivity is set depending on the pad geometry between the chip and the substrate.

DE 199 05 807 A describes a method of manufacturing electrically conducting connections, wherein bumps are applied onto individual contacts of electronic devices to obtain a connection with a conductor-line structure of a substrate, the conductor-line structure and the contacts directly touching each other.

DE 198 53 805 A describes an adhesive film exhibiting a thermoplastic polymer, resins, epoxide resins with hardening agents, metalized particles and spacer particles.

It is the object of the present invention to provide a method which allows connecting a chip and a substrate by means of a conductive adhesive at reduced expenditure in terms of production engineering.

This object is achieved by a method as claimed in claim 1.

The present invention provides a method of connecting a chip and a substrate by means of a conductive adhesive including conductive particles, the chip having at least one pad on one side thereof, the substrate having at least one pad on one side thereof, at least one of the pads projecting with regard to a substrate surface or a chip surface, the method comprising:
(a) applying the conductive adhesive to that side of the substrate on which the pad is located, and/or to that side of the chip on which the pad is located;
(b) joining the chip and the substrate, the pads of the chip and the substrate being aligned one below the other;
(c) applying, to the joined arrangement, a pressure selected such that in the region between the pads of the chip and of the substrate, local compaction of the adhesive results, and the conductive particles adhere to the pads; and
(d) hardening the conductive adhesive.

The pressure force applied is set depending on the viscosity of the adhesive, and preferably ranges between about 50 g and 500 g (grams).

In accordance with a preferred embodiment, hardening in step (d) is performed without pressurization.

The local compression performed in the step (c) leads to an increase in the ratio of the number of conductive particles between the pads to the amount of adhesive between the pads, the conductive particles merging to form one or several particle conglomerates when the percolation threshold is exceeded.

In accordance with a preferred embodiment, the degree of filling ranges between about 26% and about 40%. The joint thickness is preferably between 2 μm and 50 μm.

The adhesive is disposed at a predefined joint thickness between the pad of the chip and the pad of the substrate, the joint thickness being determined by the maximum diameters of the conductive particles in the conductive adhesive. In accordance with a preferred embodiment, the array is pressurized such that the resulting joint thickness is smaller than the predefined joint thickness.

In accordance with an embodiment, steps (b) and (c) may be performed jointly, so that pressure is applied when the chip and the substrate are adjusted.

Unlike the approaches known in the prior art, wherein a conductive glue is used with which a conductive connection requires hardening to be effected under pressure, the present invention suggests an improved approach which is less expensive, in particular in terms of production engineering. The proportion of conductive particles in the glue is selected such that, without any prior pressurization, there will be no or only very little conductivity (MOhm range) after hardening. By means of pressurization, local compaction in the region of the contact elevations and adhesion of the conductive particles, which are preferably also combined to form a conglomerate, are achieved. As a consequence, further processing may also be performed without pressurization.

Unlike in the prior art, this electrical connection is retained even if compression is followed by relaxation.

Thus, hardening no longer needs to be effected under pressure. Even if additional pressure is applied during hardening, e.g. to lower the contact resistance a bit further still, handling prior to hardening may be effected without pressurization.

An advantage of the inventive method is that a connection of chip and substrate is made possible independently of the pad geometry at hand, so that the costly determinations of necessary parameters of the adhesive, which have had to be made in the prior art, are avoided.

The present invention teaches a method which is particularly advantageous for contacting multipole unpackaged devices, such as ICs (integrated circuits), at relatively low current requirements. Here, the steps of mechanical attachment and electrical contacting are performed in one step. The inventive method is very simple and easy to automate. This is of interest, in particular, wherever very low-cost production is vital. A typical application is contacting of ICs in contactless chip cards or “smart labels”. These include, for example, thin ICs embedded in thin substrates. This is a particularly fast-growing market segment. For labeling everyday-life products, such as in supermarkets, a “smart label” must become even cheaper in the future. Savings potentials may be found in the field of label production, i.e. the costs of chip assembly must be reduced further.

However, the potential applications are not limited to unpackaged devices. The method may also be applied to packaged devices, in particular to so-called chip-sized packages (CSP), such as micro-ball grid arrays, wherein the package size is not very much larger than the chip size. In addition, the inventive method may advantageously be employed with single multipole connections.

A preferred embodiment of the present invention will be explained below in more detail with reference to the accompanying drawings, wherein:

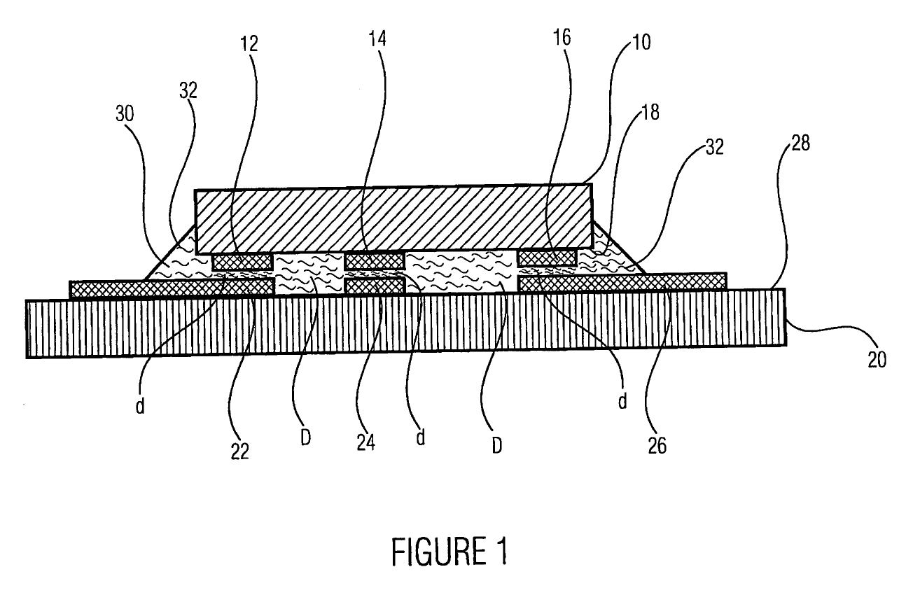

FIG. 1 is a sectional representation of a chip/substrate array produced in accordance with the inventive method.

FIG. 1 shows a chip 10 comprising a plurality of pads 12, 14 and 16 arranged on a side 18 of chip 10. In addition, a substrate 20 is shown which also comprises a plurality of pads 22, 24, 26 formed on a side 28 of the substrate. Side 18 of chip 10 is arranged opposite side 28 of substrate 20, a conductive adhesive 30 being disposed between substrate 20 and chip 10. An adhesive joint d, wherein the conductive adhesive 30 is disposed at a predefined thickness, is formed between the pairs of pads 12, 22; 14, 24; and 16, 26, respectively. Outside these regions, i.e. in regions wherein no pads oppose each other, the resulting adhesive joint D is clearly larger than the adhesive joint d resulting between the pads.

Chip 10, which is shown in FIG. 1, may be, for example, a transponder chip or an RFID chip (RFID=radio frequency identification) which may be embedded into a “smart label”. Alternatively, chip 10 may also include a diode or another active or passive device.

In accordance with the invention, for manufacturing the array shown in FIG. 1, use is made of the possibility of contacting conductive particles 32, which are evenly distributed in the resin matrix of adhesive 30, at a pressure applied once for a short time, . . . with each other and with the pads of substrate 20 and chip 10 so as to simultaneously establish mechanical attachment between chip 10 and substrate 20. The proportion of conductive particles in the resin matrix is selected such that, without any prior pressurization, there will be no or only very little conductivity (MOhm range) after hardening. As an alternative to using chip 10, a second substrate may naturally also be used for connection with substrate 20.

The course of procedure for manufacturing the element shown in FIG. 1, i.e. for contacting and affixing components 20 and 10, is as follows. Initially, a sparingly filled glue is provided. In accordance with a preferred embodiment, this sparingly filled glue is applied onto surface 28 of substrate 20, and chip 10 is placed thereon. In this procedure, pads 12, 14 and 16 of chip 10 are adjusted with pads 22, 24 and 26 of substrate 20. During this adjusting process, or subsequently thereto, the resulting component is subjected to short-term pressurization, so that in the region between the pads of chip 10 and substrate 20, the adhesive is locally compacted, and conductive particles 32 adhere to pads 12, 14, 16, 22, 24, 26. Local compaction results in an increase in the ratio of the number of conductive particles 32 between pads 12, 14, 16, 22, 24, 26 and the amount of adhesive between the pads. Preferably, use is made of “flocculent” conductive particles (flakes), e.g. made of silver, which additionally combine into one or several particle conglomerates due to the pressure applied between the pads—however, this does not occur in the remaining regions (i.e. those regions which have no pads opposite them). Instead of the “flocculent” conductive particles (flakes), differently shaped particles may also be used. Such particles, too, combine into one or several particle conglomerates.

The pressure force applied is set in dependence on the viscosity of the adhesive and preferably ranges between about 50 g and 500 g.

A predetermined adhesive gap d of preferably a few μm is formed between pads 12 to 16 of chip 10 and pads 22 to 26 of substrate 20. The adhesive gap minimally possible depends on the shape and size of the filling material, preferably flakes, as with silver-filled glues. By means of this force being applied, the conductive particles 32 are contacted with each other and with the pads of chip 10 and substrate 20 in the region of the pads. The pads of chip 10 and substrate 20 form the highest elevations above the respective surfaces 18 and 28, respectively. In the regions between the pads, the adhesive gap D is significantly larger, so that here the glue is not exposed to such a high pressure and so that hardly any contact is caused between particles 32. This corresponds to high insulation resistance between the pads.

By means of the inventive method, high resistance (in the MΩ range) results between the substrate and the chip in regions with gap D. However, the resistance will be only several Ω or less between the pads. Thus, good contacting is achieved, in accordance with the invention, between the pads while achieving high insulation resistance between the remaining regions, which is effected without having to apply any pressure when hardening this compound. If the contact resistance needs to be lowered a bit more still (by several tenths of Ω), pressure may be applied during hardening. However, what must be emphasized is that there is an electrical connection after compressing the components, so that, irrespective of whether or not any pressure is applied during hardening, there is no necessity to still keep the pressure constant. This considerably relieves handling of the individual components.

When connecting two substrates, e.g. film strips, in a multipole manner, the procedure adopted is analogous to the above description, with, the exception that chip 10 is replaced by a second substrate.

The inventive approach further allows providing the glue independently of the actual geometry of the pads on chip 10 and substrate 20, so that such a glue may be provided for a multiplicity of any pad geometries desired. In accordance with the invention, good contact exhibiting high conductivity is ensured between the pads, while high insulation resistance is ensured, at the same time, for the region between the pads.

With regard to the conductive glue, or adhesive, it is to be stated that one may differentiate, in principle, between filled and unfilled epoxides. The filled glues are subdivided into electrically conducting and heat-conducting glues. Materials filled with silver play the most important role among the electrically conducting glues. For cost reasons, glues filled with gold play a minor role. Due to their poor electrical conductivity, glues filled with nickel and copper are not very common. Filling materials comprising gold, silver, nickel and copper having a proportion of filling material between 70% and 80% (weight fraction) may be used as electrically conductive glues which are also thermally conducting.

The resistivity of glues filled with silver range from 4×10⁻⁴ Ω×cm to 7×10⁻⁶ Ω×cm, depending on the material and hardening cycle. In comparison thereto, the resistivity of glues filled with gold is about 1.6×10⁻⁶ Ω×cm, and that of glues filled with copper is about 1.7×10⁻⁶ Ω×cm.

The adhesives used for the present invention are obtained by mixing non-conducting and conducting glues, a degree of filling from 26.6% to 40% having proved advantageous for an adhesive joint d ranging between 5 μm and 50 μm.

Here, the adhesive joint which may be achieved as a minimum is always determined by the maximum particle diameter of the conductive particles 32 dispersed in the glue. With commercial conductive glues, this particle size ranges between about 4 μm and about 50 μm (with conductive glues having conductive nano particles, the particle size is even smaller—since individual nano particles adhere to each other, the smallest particle size here is about 1 μm). An example considered here is adhesive H20E-PFC by Polytec, having an average particle size of 4 μm and a maximum particle size of 10 μm. The minimum adhesive joint d will then be 10 μm. However, if one takes into account that at a higher joint pressure, the conducting particles are squashed between the contact pads, this results in a minimum adhesive joint of 8 μm, it being impossible to achieve an average adhesive joint of between 10 μm and 15 μm.

Depending on this achievable adhesive joint, the degree of filling of the glue is then set by mixing filled (conductive) and unfilled (non-conductive) glues so as to obtain a conductive glue for the connection between the two devices which is independent of geometry.

Preferably, the present invention is used to produce arrays wherein as high a throughput as possible is to be achieved.

Preferably, this adhesive technology is a flip-chip connection directed at achieving as high a throughput as possible. Flexible substrate material, e.g. PET or paper, is predominantly used as the circuit support. With flexible support substrates, flexibility may play a decisive role. The flexibility, or pliability, of the support material is dependent on the size of the adhesive joint; the smaller the adhesive joint, the higher the flexibility between the chip and the support material. If one takes into account that the thermal energy is to be dissipated away from chip 10 to substrate 20 or a heat sink, this joining technology has a further advantage compared with conventional flip-chip connections, which results from the fact that not only electrical conduction, but also the heat conduction required may be achieved via the particles, or particle conglomerates.

If one finds, after applying pressure to the array, that the distance between the components increases again after removing the pressure, it may be advisable to select the pressure such that initially an adhesive joint will form which is smaller than the joint desired so as to eventually obtain the desired joint thickness despite any potential relaxation.

Thus, the inventive method comprises a multiplicity of advantages over other methods known in the prior art. For example, application of adhesive may be performed by any method desired, e.g. by stamping, dispensing, printing, dipping, etc. For positioning the ICs in an adjusted manner, mechanical pressure is required only in that the distance between the pads becomes small so as to achieve the desired compaction and adherence of the conductive particles. No pressure is required for hardening the glue, so that what results is good automatability and suitability for outright mass production. In addition, no underfiller is required, since the IC is glued on over the whole surface area. The requirements placed upon the alignment accuracy are relatively small, and in addition, what results is an extremely small structural height, which is important, in particular, with flat applications, such as “chip-in-paper”.

Even though an example having three pads on the chip and the substrate, respectively, has been described above, the present invention is not limited thereto. Rather, any number of pads may be employed.

Instead of the connection of chip and substrate, which has been described by means of the preferred embodiment, any structures may be connected, in accordance with the invention, to at least one pad, respectively, e.g. chip and chip, or chip and wafer.

1-7. (canceled)

8. A method of connecting a chip having pads on one side and a substrate having pads on one side by means of a
conductive adhesive including conductive particles, independently of the pad geometry, the pads of the chip and/or of the substrate projecting with regard to a surface, the method comprising:
(a) applying the conductive adhesive to that side of the substrate on which the pads are located,
and/or to that side of the chip on which the pads are located, the conductive adhesive comprising a multiplicity of conductive particles which are substantially evenly spread in a resin matrix;
(b) joining the chip and the substrate, the pads of the chip and the substrate being aligned one below the other;
(c) applying, to the joined arrangement, a pressure selected such that in the region between the pads of the chip and of the substrate, local compaction of the adhesive results, and the conductive particles adhere to the pads; and
(d) hardening the conductive adhesive without pressurization.

9. The method as claimed in claim 8, wherein the local compaction in step (c) results in an increase in the ratio of the number of conductive particles between the pads to the amount of adhesive between the pads.

10. The method as claimed in claim 8, wherein in step (c), the conductive particles combine into one or several particle conglomerates when the percolation threshold 1 s exceeded.

11. The method as claimed in claim 8, wherein the degree of filling of the conductive adhesive ranges between about 26% and about 40%, and wherein the joint thickness ranges from about 2 μm to about 50 μm.

12. The method as claimed in claim 8, wherein the adhesive between the pad of the chip and the pad of the substrate is disposed at a predetermined joint thickness, the predetermined joint thickness being determined by the maximum diameter of the conductive particles in the conductive adhesive.

13. The method as claimed in claim 12, wherein in step (c), the arrangement is pressurized such that the resulting joint thickness is lower than the predetermined joint thickness.

14. The method as claimed in claim 8, wherein steps (b) and (c) are performed jointly, so that pressure is applied when adjusting the chip and the substrate.
